(19) United States
(12) Patent Application Publication
(10) Pub. No.: US 2016/0237632 A1
(43) Pub. Date: Aug. 18, 2016

(54) FILMS AND METHODS FOR PROTECTING ROADSIDE POLES

(71) Applicant: Can-Traffic Services Ltd., Sherwood Park (CA)

(72) Inventor: Michael Mitchell, Sherwood Park (CA)

(21) Appl. No.: 14/625,244

(22) Filed: Feb. 18, 2015

(51) Int. Cl. E01F 9/011; B32B 37/10; B32B 37/12

(52) U.S. Cl. CPC E01F 9/011; B32B 37/12; B32B 37/10; B32B 2309/105; B32B 2309/16; B32B 2597/00

(57) ABSTRACT

Methods and apparatuses for protecting roadside poles, for example using protective films. The films may include a corrosion inhibitor and may be sufficiently resilient to pass a standard gravelometer test.

### TECHNICAL FIELD

This document relates to films and methods for protecting roadside poles.

### BACKGROUND

Over time, poles erected adjacent a road experience physical damage from flying rocks and corrosion from road salt, resulting in chipped paint and rust. Weathered poles are replaced or sanded down and re-painted.

### SUMMARY

A method comprising: applying a protective film around a roadside pole, with an adhesive layer of the protective film contacting the roadside pole, the protective film, for example the adhesive layer, containing a corrosion inhibitor.

A method comprising: applying a clear transparent protective film to a roadside pole, with an adhesive layer of the protective film contacting the roadside pole.

A method comprising: applying a barrier liquid to one or both a portion of a roadside pole or an adhesive layer of a protective film; applying the protective film to the portion of the roadside pole, with barrier liquid positioned between the adhesive layer and the portion of the roadside pole; and applying pressure to the protective film to displace the barrier liquid and adhere the protective film to the roadside pole.

An apparatus comprising: a roadside pole extended from a ground engaging base; and a protective film wrap applied around and adhered to the roadside pole, the protective film having a sufficient chip resistance to pass standard test SAE J400 (Test for Chip Resistance of Surface Coatings).

Methods of protecting stationary roadside devices such as poles are also disclosed. Treated poles mount streetlights, traffic lights, crosswalks, advance warning flashers and any other pole mounted traffic control or aid devices. Paint protection film may be used to protect such devices.

In various embodiments, there may be included any one or more of the following features: The roadside pole mounts one or more of a street light, traffic light, or traffic control device. The roadside pole mounts a street light. The protective film is applied around the roadside pole at the base of the roadside pole. The protective film is stretch wrapped around the roadside pole. Opposite ends of the protective film abut one another after application. The roadside pole is ground-mounted adjacent a road. The protective film further comprises: a cap sheet; a urethane polymer layer; and a pressure sensitive adhesive within the adhesive layer. The protective film is a clear transparent film. The protective film comprises a reflective coating. Applying the protective film further comprises: applying a barrier liquid to one or both a portion of the roadside pole or the adhesive layer; applying the protective film around the portion of the roadside pole, with barrier liquid positioned between the adhesive layer and the portion of the roadside pole; and applying pressure to the protective film to displace the barrier liquid and adhere the protective film to the roadside pole. The protective film has one or more of the following properties: a sufficient chip resistance to pass standard test SAE J400 (Test for Chip Resistance of Surface Coatings); an elongation break point of 200% or greater; and a tensile break point of 12 MPa or higher; and a thickness of less than 0.360 mm. The protective film further comprises one or more of a mold inhibitor, an anti-graffiti coating, and a UV stabilizer. The roadside pole has an outer surface portion containing rust, and in which applying the protective film further comprises: removing the rust on the outer surface portion; painting the outer surface portion; and applying the protective film to the painted outer surface portion of the roadside pole. The protective film comprises Ventureshield™. Pressure is applied by passing a squeegee over the applied protective film. The barrier liquid comprises water, soap, and isopropyl alcohol.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a side elevation view of a roadside street light pole being prepared for application of a protective film.

FIG. 2 is a side elevation view of the pole of FIG. 1 with a protective film being stretch-wrapped around the pole.

FIG. 3 is a side elevation view of the pole of FIG. 2 during application of pressure against the film to adhere the film to the pole.

FIG. 4 is a side section view of a protective multi-layer film applied to the pole in FIG. 1.

FIG. 5 is a side elevation view of a traffic light supported by a pole wrapped in a protective film.

FIG. 6 is a side elevation view of a blank of film cut to fit a tapered pole.

### DETAILED DESCRIPTION

Immaterial modifications may be made to the embodiments described here without departing from what is covered by the claims.

Various pole mounted devices are positioned adjacent roads, including walkways. Such devices have a variety of purposes, such as road lighting or traffic guidance. Road lighting is often provided by street lights, also referred to as lampposts, street lamps, light standards, or lamp standards. A street light comprises a light illuminating a road, typically mounted on a tall pole, and often overhanging a road or walkway.

Traffic guidance is provided by traffic control devices. Traffic control devices include markers, signs and signal devices used to inform, guide and control traffic, including pedestrians, motor vehicle drivers and bicyclists. Such devices are usually placed adjacent, over or along the highways, roads, traffic facilities and other public areas for traffic control. Traffic signs include signs that use symbols or words to convey information to road users. Traffic signs may convey regulatory, warning, or advertising information. Variable Message Signs are traffic control devices which can exhibit different traffic messages according to the needs of a specific road. Permanent displays may be mounted on large sign structures overhead or alongside the road. Traffic lights include traffic control devices used for alternately assigning right-of-way to traffic moving in conflicting directions at an intersection. Typical traffic lights may feature three different lights, such as red, yellow, and green, that each convey different meanings

Pole mounted roadside devices may be mounted to the ground or road in a permanent or temporary fashion. Permanent mounting may be achieved using a foundation such as a concrete pile with embedded bolts arranged to engage and secure a base connected to the supporting pole. Other permanent mounting methods include insertion of the pole into the ground, in some cases preceded by drilling a hole and cementing the pole in place within the hole. Many permanently mounted devices that require power may be connected underground to a source of power or control lines. Temporary mounting may be achieved by resting a base on the ground, the base mounting the pole.

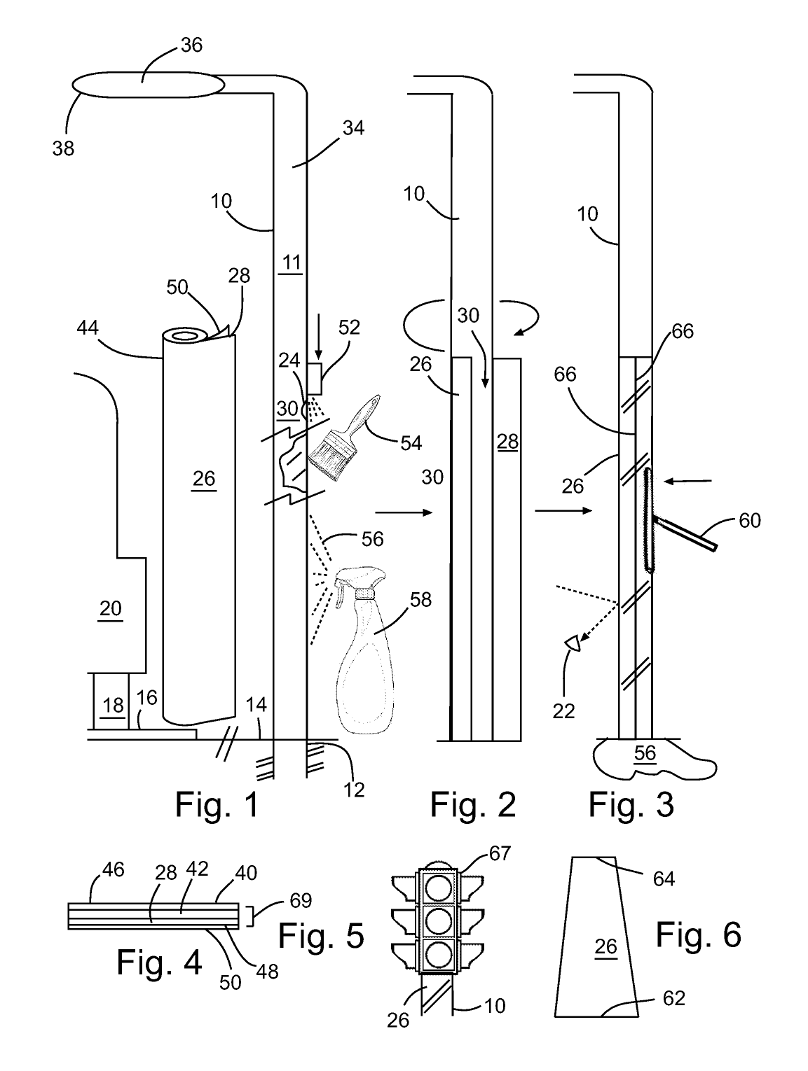

Referring to FIG. 1, a roadside pole 10, in this case mounting a street light, is illustrated. Such poles 10 may have an outer surface 11 coated with paint or another weather resistant covering such as galvanization. Pole 10 may extend from a ground engaging base 12, which as shown may form the part of the pole 10 that is extended below a ground surface 14. Thus, pole 10 may be ground-mounted. Pole 10 is positioned adjacent a road 16, for example within an exposure zone originating and extending laterally outwards from road 16, and representing an area that is exposed to physical and chemical debris expelled from road 16 during use of the road 16. Debris is commonly kicked up by tires 18 of vehicles 20 travelling on the road 16 and contacts pole 10 during use (see FIG. 3 for an example of a rock 22 kicked up from road 16). Over time, continual exposure to debris tends to break down any protective coating on pole 10, leading to an unsightly appearance of the pole 10 and eventually damaging and weakening the integrity of the pole 10 itself. Physical debris such as rocks 22 (FIG. 3) periodically contact the outer surface 11, leading to chipped paint and metal. Chemical debris such as road salt deposited during the winter may act upon exposed pole 10 metal, leading to the formation of rust 24 patches on outer surface 11.

Referring to FIGS. 1-3 a method of repairing a damaged or weathered pole 10 is shown, in this case mounting a street light with a mast 34, boom 36, and boom-mounted lamp 38. The disclosed methods may also be adapted to protect new poles before, during, or after, field installation. In the sequence shown a protective film 26 is applied around the pole 10, for example a base portion 30 of the pole. The film 26 is applied such that an adhesive layer 28 of the protective film 26 contacts and adheres to the pole 10. The film 26 may be applied, for example wrapped, around the pole 10 at a base 32, of the pole 10, above ground level and extending to cover portion 30 at a desired height or in other cases to cover the entire height of the pole 10 (FIG. 5). When the disclosed methods are used on poles 10 prior to installation in the ground 14, the film 26 may or may not cover portions, such as ground engaging base 12, that extend below the ground 14 in use.

Various processes may be carried out to condition the pole 10 or film 26 prior to wrapping the film 26 onto the pole. The pole 10 may be cleaned first, for example using a solution of water, soap, and in some cases alcohol, to remove dust and grit. All wax polish may be removed from the main pole areas to be protected. Areas that may be cleaned include those where the film is likely to be positioned, tucked or folded, and the removal of any silicone waxes, oil, and dirt should be thoroughly ensured from these areas.

Rust 24 may be removed, for example by sanding down the rust 24 zones with an abrasive device such as a sand paper block 52. Rust removal may be carried out on a portion 30 of the outer surface 11 using suitable methods such as blasting with sand or other abrasive components such as dry ice. After rust removal the outer surface portion 30 may be cleaned, and painted or primed, for example using a suitable painting process such as a brush 54 or spray system. After the paint is permitted to dry the film 26 may be applied to the portion 30, for example the entirety, of the pole 10.

To apply the film a suitable film application method may be used. A barrier liquid 56 may be applied, using a suitable dispensing device such as a spray bottle 58, to one or both the portion 30 of the roadside pole 10 or the adhesive layer 28. The barrier liquid may comprise water and soap, and in some cases an alcohol such as isopropyl alcohol. The barrier liquid may also be used to clean the pole 10 as above. The soap may be an off-the-shelf soap, such as baby shampoo made by JOHNSON & JOHNSON™. When the protective film 26 is applied around the pole, barrier liquid thus becomes sandwiched between the adhesive layer 28 and the pole 10. The soap and water act as a lubricant to permit the film 26 to be properly positioned before adhesion takes place. The alcohol acts as a cleaning agent to remove undesirable water-insoluble deposits on the outer surface 11, such as wax or oil. The barrier liquid may be applied as a fine mist coating over the entire portion 30 of pole 10. Fingers and hands may be sprayed with the barrier liquid to reduce the chance of fingerprint transfer to the adhesive layer 28.

The film 26 may be cut to size from a roll 44, and a release liner 50 removed from adhesive layer 28 prior to contacting the pole 10 (FIG. 1). In other cases the film 26 may be pre-cut for the particular pole size and shape. Referring to FIG. 6 a pre-cut film 26 is illustrated having a shape selected to fit a particular pole shape, in this case forming a parallelogram with a width that reduces with distance from a base 62 to a top 64, corresponding to a pole 10 with a gradually reducing diameter from base to top. In other cases the film 26 is partially applied and then cut to size.

While or during the film 26 is applied but before substantial adherence takes place, the film 26 may be stretch-wrapped or elongated around the pole 10 (FIG. 2). Stretching the film 26 permits the film 26 to hug and conform with the shape of the pole 10, particularly if the pole 10 has a non-symmetrical or complex outer shape. Once the film 26 is in position, pressure may be applied (FIG. 3) to the protective film 26, for example using a squeegee 60 to displace the barrier liquid 56 and adhere the protective film 26 to the roadside pole 10. Application of pressure may activate any pressure sensitive adhesive component. Pressure may also remove bubbles, wrinkles, and creases in the film 26, ensuring a tight adhering fit to the pole in conformance with the shape of the pole 10. A tight fit acts as a natural barrier to water, oxygen, and chemical ingress, thus prolonging the effectiveness of the film treatment. The film 26 may be applied such that opposite ends 66 of the protective film 26 abut one another to produce a flush unitary surface (FIG. 3).

Referring to FIG. 4, an example protective film 26 is illustrated. The film 26 shown is a multilayer film, comprising in sequence an outer coating, such as a cap sheet 40, an intermediate protective layer, such as a urethane polymer layer 42, and adhesive layer 28, for example containing a pressure sensitive adhesive. The cap sheet 40 defines an external face 46, namely the surface of film 26 that is directed towards the outside environment after application. The adhesive layer 28 defines an internal face 48, namely the surface of film 26 that contacts or is directed towards the substrate, in this case the pole 10, after application. Film 26 may be stored in a suitable pre-application form for example in a roll 44 (FIG. 1), and in some cases with a removable release liner 50 overlying the adhesive layer 28 (FIG. 4). One or more or all layers may be bonded, for example cross-linked to, adjacent layers to form a unitary film 26.

The film 26, for example the adhesive layer 28, may contain a corrosion inhibitor. Various classes of corrosion inhibitors exist, such as anodic, cathodic, mixed anodic and cathodic, adsorptive agents, and volatile corrosion inhibitors.

Anodic inhibitors (also called passivation inhibitors) act by a reducing anodic reaction, by blocking the anode reaction and supporting the natural reaction of passivation metal surface, as well as by forming a film adsorbed on the metal. In general, inhibitors react with the corrosion product, initially formed, resulting in a cohesive and insoluble film on the metal surface. Such inhibitors are also sometimes referred to as passivators. Chromates, nitrates, tungstate, molybdates, vanadates, phosphates, and borates are examples of anodic inhibitors.

By contrast, cathodic corrosion inhibitors prevent the occurrence of the cathodic reaction of the metal. Such inhibitors may have metal ions able to produce a cathodic reaction due to alkalinity, thus producing insoluble compounds that precipitate selectively on cathodic sites, and deposit over the metal a compact and adherent film, restricting the diffusion of reducible species in these areas. Thus, such inhibitors increase the impedance of the surface and the diffusion restriction of the reducible species, that is, the oxygen diffusion and electrons conductive in these areas. The corrosion rates can also be reduced by the use of oxygen scavengers that react with dissolved oxygen. Sulfite and bisulfite ions, as well as antioxidants, such as amines and hydrazines, are examples of oxygen scavengers that can combine with oxygen to form sulfate. Cathodic examples include Ce, Y, La, Eu, Gd, Pr, and Nd compounds.

Mixed inhibitors work by reducing both the cathodic and anodic reactions. They are typically film forming compounds that cause the formation of precipitates on the surface blocking both anodic and cathodic sites indirectly. Examples include silicates, phosphates, salts such as ZnH2PO4.

Adsorptive corrosion inhibitors act via the process of surface adsorption, designated as a film-forming. The occurrence of molecules exhibiting a strong affinity for metal surfaces compounds showing good inhibition efficiency and low environmental risk. Such inhibitors may build up a protective hydrophobic film of adsorbed molecules on the metal surface, which provides a barrier to the dissolution of the metal in any adjacent electrolyte medium. Such inhibitors may be soluble or dispersible in the medium surrounding the metal. Such adsorbed entities provide a low electrolytic, low ion-transporting property that enhances corrosion protection by limiting ion transport within the film 26.

Volatile Corrosion Inhibitors (VCI), also called Vapor Phase Inhibitors (VPI), are compounds transported in a closed environment to the site of corrosion by volatilization from a source, for example a slow release volatile solid contained in the film 26. Examples include morpholine, hydrazine, and salts of dicyclo-hexylamine, cyclohexylamine and hexamethyleneamine. When such inhibitors come in contact with the metal surface, the vapor of these salts condenses and is hydrolyzed by any moisture to liberate protective ions. In some cases the film 26 may be nanostructured with a ‘smart’ coating that can release corrosion inhibitors on demand when the coating is breached or stressed. Inherently conducting polymer films containing inhibiting anions as the dopant anions can release them when the film is coupled to a breach in the coating.

Examples of corrosion inhibitors include mercaptans, salts of Zn, Bi, Co, Ni, Cd, Pb, Ag, Sb, Cu, Li, Ca, Sr, Mg, La, Ce, Pr, Al, Zr, phosphates, molybdates, borates, silicates, tungstates, phosphotungstates, phosphomolybdates, cyanamides, carbonates, SiO2, barium nitrate, amine nitrites, sodium gluconate, benzotriazole, tolyltriazole, molybdate, tungstate, ZnSO4, hydrotalcite, polysaccharides, polyaniline, permanganate soldalite, silanes, and mixtures of one or more other compounds.

The corrosion inhibitor may be provided in a medium that has a soft texture or is a paste, in order to fill gaps and pits in the outer surface 11 when pressure is applied to the adhesive layer to contact the outer surface 11. The inhibitor may be added during polymerization of one or more parts of the film 26, for example when reacting a di- or polyisocyanate with a polyol to form a polyurethane part of the film 26. The corrosion inhibitor may be part of or associated with a side chain in the film polymer matrix, in some cases. The corrosion inhibitor may be present in part or the entire film 26.

Corrosion inhibition may be further improved by combination with providing various physical characteristics, to the film, that are designed to reduce corrosion. For example one or more layers or the entirety of the film may comprise a liquid and water vapor barrier. The film, for example adhesive layer 28, may have a makeup that blocks transport of ions across the film 26. A preparatory primer that displaces moisture, pacifies oxides, and fills small irregularities that occur on the surface, may be used prior to application of film 26.

The cap sheet may be a clear coat. The cap sheet may comprise one or more of an at least partially crosslinked polyurethane, a polyester-based polyurethane, and a polycarbonate-based polyurethane. The cap sheet may comprise a cross-linked polyurethane layer made of a polycarbonate based polyurethane containing acid groups and cross-linked with a cross-linker, the polycarbonate based polyurethane comprising the reaction product of a polycarbonate polyol or a polycarbonate polyamine and an aliphatic polyisocyanate and the uncross-linked polycarbonate based polyurethane. The cap sheet may comprise a fluoro-containing polymer layer for example comprising a fluoroelastomer, a perfluoro-acrylate homo- or copolymer, or a perfluoro-vinyl non-acrylate homo-or copolymer. The topcoat layer may also comprise a silicone polymer.

The intermediate protective layer (urethane) 42 may be clear and non-yellowing under prolonged exposure to sunlight. The urethane polymer layer may comprise thermoplastic polyurethane, such as a polycaprolactone-based thermoplastic polyurethane. Polyurethane layers may be made from the reaction products of a hydroxy-containing material (base material) and isocyanate-containing material (activator) for example, polyisocyanate.

The adhesive layer 28 may comprise an acrylic-based material or rubbery polymer or copolymer. For example, a high performance acrylic adhesive may be used. The adhesive may withstand lubricants, oils, UV rays, and as above may contain an anti-corrosion polymer which inhibits rust and mold growth. The adhesive layer 28 may be a pressure sensitive adhesive. In other cases a thermally activated adhesive may be used. A pressure sensitive adhesive may be based on polyacrylates, synthetic and natural rubbers, styrene-isoprene-styrene block copolymers, polybutadiene and copolymers or polyisoprenes and copolymers. Silicone based adhesives such as polydimethylsiloxane and polymethylphenylsiloxane may also be used. Polyacrylate based adhesives may be used because such provide such properties as high clarity, UV-stability and aging resistance. Adhesives may comprise a cross-linked copolymer of a C4-C12 alkylacrylate and an acrylic acid. The polyacrylate pressure sensitive adhesive may also comprise a tackifier such as rosin ester. Adhesives may incorporate additives such as ground glass, titanium dioxide, silica, glass beads, waxes, tackifiers, low molecular weight thermoplastics, oligomeric species, plasticizers, pigments, metallic flakes and metallic powders.

Referring to FIG. 3, the film 26 may possess one or more of the following properties. In some cases the film 26 may have sufficient chip resistance to pass standard test SAE J400 (Test for Chip Resistance of Surface Coatings). An analogous test is the ASTM Method D-3170 Chipping Test. In such tests a bucket of gravel is propelled under high pressure against a sample of film 26. The machine that propels the gravel is called a gravelometer. The test is carried out under controlled temperature conditions. After impact, tape is applied to remove any loose paint chips remaining on the test panel, and the degree of chipping is determined by a visual inspection. A pass is achieved when no chips are observed after the test.

The film 26 may possess an elongation break point of 200% or greater. Thus, the film 26 may be stretched up to 200% and in some cases 400% or more past its original length, in order to conform smoothly around complex shapes when stretch-wrapped. Elongation may be tested using standard test 3M DCC 654 for example.

The film 26 may possess a tensile break point of 12 MPa or higher, for example 20 MPa or higher. A relatively high break point means that the film 26 is relatively more resistant to punctures from flying rocks 22 as shown.

The film 26 may possess a thickness of less than 0.360 mm, for example 0.213 mm (8.4 mils) in some cases, as measured by standard test 3M DCC654. Chip resistance may be increased by thickening the film 26, for example by thickening the intermediate urethane layer 42.

The adhesive layer 28 may possess one or more of the following performance properties, all tested by standard test 3M DC C654—the 180° Peel Adhesion (Standard Paint): Initial—1 hr at Room Temp (RT) 4.0 lb/in. (700 N/m), 72 hrs at RT 5.1 lb/in. (900 N/m), Heat Resistance—168 hrs at 80° C. 5.7 lb/in. (1,000 N/m), Moisture Resistance—168 hrs at 50° C./95% RH 6.3 lb/in. (1,100 N/m). One suitable film 26 that achieves the above mentioned properties is VENTURESHIELD™ made by 3M™.

The protective film 26 may be a clear transparent film. Thus, the film 26 may be applied over the surface 11 of the pole 10 without detracting or modifying the color of the pole 10, such as the color of the paint overlying the pole 10. In other cases, one or more pigments may be included within the film 26, in order to give the film 26 a colored appearance, from complete transparency, to a partial transparent but tinted appearance, to an opaque colored appearance. In some cases the color of the film 26 matches the color of the pole 10. In the repair of a weathered pole example above in some cases after rust removal a colored film 26 may be applied, with or without application of paint. Clear transparent refers to a property that permits full passage of visible light. In some cases other ranges of electromagnetic radiation may be blocked, such as UV rays.

In some cases the protective film 26 comprises a reflective coating, for example one containing metallic flakes, metallic powders, glass beads, or ground glass. The protective film 26 may further comprises one or more of a mold inhibitor, an anti-graffiti coating, and a UV stabilizer. An anti-graffiti coating may be provided in the cap sheet, for example by providing a cap sheet with a hydrophobic water repellant surface that is difficult to write on, or that has low adherence to, or does not bond with, external substances such as spray paints. For example silicon, nanoparticle-containing, oleophobic and hydrophobic, or fluorinated coatings may be used, as may coatings with high chain stiffness and high crosslinking density that reduces the ability of the polymer to swell and absorb graffiti paint. Referring to FIG. 5, an example is shown of a traffic light 67 with a supporting pole 10 covered from base to light with a protective film 26. The pole 10 may have a circular or non-circular cross-sectional shape, such as angle iron, square, polygonal, or complex, irregular, symmetrical or non-symmetrical shapes. The traffic pole 10 may be stationary during use. Suitable poles need not be vertical, and can include branch poles and poles 10 that have not been installed. Film 26 may be wrapped partially or fully circumferentially around a pole 10. The adhesive layer 28 may be the entirety or a substantial portion of the entire thickness of the film 26. References to standard tests refer to such tests as published by 3^{rd} parties as of the filing date of this document. Urethanes include polyurethanes in some cases. The portion 30 may extend up to six, eight, or more feet above the ground surface 14. The film 26 may be rolled, optionally pre-cut, and provided in a tube, with a cap for example.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method comprising:
applying a protective film around a roadside pole, with an adhesive layer of the protective film contacting the roadside pole, the protective film containing a corrosion inhibitor.

2. The method of claim 1 in which the roadside pole mounts one or more of a street light, traffic light, or traffic control device.

3. The method of claim 2 in which the roadside pole mounts a street light and the protective film is applied around the roadside pole at a base of the roadside pole.

4. The method of claim 2 in which the protective film is stretch wrapped around the roadside pole, with opposite ends of the protective film abutting one another.

5. The method of claim 1 in which the roadside pole is ground-mounted adjacent a road.

6. The method of claim 1 in which the protective film further comprises:
a cap sheet;
a urethane polymer layer; and
a pressure sensitive adhesive within the adhesive layer.

7. The method of claim 1 in which the protective film is a clear transparent film.

8. The method of claim 1 in which the protective film comprises a reflective coating.

9. The method of claim 1 in which applying the protective film further comprises:
applying a barrier liquid to one or both a portion of the roadside pole or the adhesive layer;
applying the protective film around the portion of the roadside pole, with barrier liquid positioned between the adhesive layer and the portion of the roadside pole; and
applying pressure to the protective film to displace the barrier liquid and adhere the protective film to the roadside pole.

10. The method of claim 9 in which pressure is applied by passing a squeegee over the applied protective film.

11. The method of claim 10 in which the barrier liquid comprises water, soap, and isopropyl alcohol.

12. The method of claim 1 in which the protective film has a sufficient chip resistance to pass standard test SAE J400 (Test for Chip Resistance of Surface Coatings).

13. The method of claim 1 in which the protective film has an elongation break point of 200% or greater.

14. The method of claim 1 in which the protective film has a tensile break point of 12 MPa or higher.

15. The method of claim 1 in which the protective film has a thickness of less than 0.360 mm.

16. The method of claim 1 in which the protective film further comprises one or more of a mold inhibitor, an anti-graffiti coating, and a UV stabilizer.

17. The method of claim 1 in which the roadside pole has an outer surface portion containing rust, and in which applying the protective film further comprises:
removing the rust on the outer surface portion;
painting the outer surface portion; and
applying the protective film to the painted outer surface portion of the roadside pole.

18. The method of claim 1 in which the protective film comprises Ventureshield™.

19. A method comprising:
applying a clear transparent protective film to a roadside pole, with an adhesive layer of the protective film contacting the roadside pole.

20. An apparatus comprising:
a roadside pole extended from a ground engaging base; and
a protective film wrap applied around and adhered to the roadside pole, the protective film having a sufficient chip resistance to pass standard test SAE J400 (Test for Chip Resistance of Surface Coatings).
